(19) United States
(12) Patent Application Publication
(10) Pub. No.: US 2026/0229068 A1
(43) Pub. Date: Aug. 6, 2026

(54) Method and Device for Controlling the Output of a Tank Ventilation Notice

(71) Applicant: Bayerische Motoren Werke Aktiengesellschaft, Muenchen (DE)

(72) Inventor: Martin RUPP, Karlsfeld (DE)

(21) Appl. No.: 19/152,559

(22) PCT Filed: Jan. 29, 2024
(86) PCT No.: PCT/DE2024/100069

§ 371 Date: Jul. 31, 2025

(30) Foreign Application Priority Data
Feb. 9, 2023 (DE) 10 2023 103 106.6

(51) Int. Cl. G07C 5/00; B60K 15/035; G06V 20/59; G06V 40/10

(52) U.S. Cl. CPC G07C 5/006; B60K 15/035; B60K 2015/03561; G06V 20/59; G06V 40/10

(57) ABSTRACT

A device for controlling the output of a tank ventilation notice prior to a possible filling operation of the fuel tank of a vehicle is configured to determine that a notice situation exists in which by default a tank ventilation notice is to be output. The device is further configured to ascertain one or more indications for whether a tank ventilation notice should be suppressed or not, and to effect or suppress the output of the tank ventilation notice depending on the one or more indications.

### BACKGROUND AND SUMMARY

The technology disclosed here relates to methods and corresponding devices for controlling the output of a tank ventilation notice.

In the case of a vehicle having a hybrid drive (for example in the case of a plug-in hybrid vehicle), it may be necessary for the user of the vehicle to cause the fuel tank to be ventilated by actuating an operating element before the fuel tank of the vehicle is filled. In order to prevent the user from forgetting to actuate the operating element for the tank ventilation, a tank ventilation notice may be output via the user interface of the vehicle and/or via a user device belonging to the user, but this can be perceived to be disruptive by the user.

A preferred object of the technology disclosed here is to reduce or eliminate at least one disadvantage of a previously known solution or to propose an alternative solution. A preferred object of the technology disclosed here is to increase the comfort of the user of a vehicle with respect to the ventilation of the fuel tank of the vehicle.

The object(s) is/are achieved by the subject matter of the independent patent claims. The dependent claims describe preferred configurations.

One aspect describes a device for controlling the output of a tank ventilation notice before a possible process of filling the fuel tank of a (motor) vehicle. The vehicle may have a hybrid drive with an internal combustion engine and an electrical drive machine. The internal combustion engine may be designed to be operated with fuel (for example gasoline or diesel) from the fuel tank.

The device is configured to determine that there is a notice situation, for which a tank ventilation notice should be output as standard. For example, it is possible to detect that the vehicle is parked (possibly at a fuel pump). Furthermore, it is possible to detect that gas has collected in the fuel tank (for example because the internal combustion engine was not operated before parking the vehicle). It can be determined on the basis of this that there is a notice situation. The tank ventilation notice may be aimed at prompting the user, in particular the driver, of the vehicle to initiate the tank ventilation of the fuel tank (for example by actuating a particular operating element on the user interface of the vehicle and/or on the user device belonging to the user). The tank ventilation notice may be an optical, acoustic and/or haptic notice.

The device is also configured to ascertain one or more indications of whether or not the tank ventilation notice should be suppressed. The one or more indications can be ascertained on the basis of:
a user profile of the user that is stored in a storage unit (for example of the vehicle and/or of a backend server);
a preference setting of the user with respect to the output of tank ventilation notices;
the frequency and/or number of previously output tank ventilation notices (within a particular interval of time);
the fact of whether or not there is a user profile (with a frequency and/or number of previously output tank ventilation notices indicated therein) stored in the storage unit for the user of the vehicle;
the identity of the user, in particular ascertained on the basis of image data from an interior camera of the vehicle; and/or
the operation of the vehicle in a guest and/or rental car mode.

The device is also configured to effect or suppress the output of the tank ventilation notice on the basis of the one or more indications. The comfort of the vehicle with respect to the tank ventilation of the fuel tank can therefore be efficiently and reliably increased.

The device may be configured (for example on the basis of the user profile of the user) to ascertain the frequency and/or the number of past outputs of the tank ventilation notice in a past interval of time. The output of the tank ventilation notice may be effected or suppressed on the basis of the ascertained frequency and/or number of past outputs of the tank ventilation notice. The output of the tank ventilation notice may be suppressed, for example, if the ascertained frequency and/or number of past outputs of the tank ventilation notice is/are greater than a threshold value. On the other hand, the output of the tank ventilation notice may be effected if the ascertained frequency and/or number of past outputs of the tank ventilation notice is/are less than the threshold value. The comfort of the vehicle can therefore be increased in a particularly reliable manner.

The device may be configured to detect that no tank ventilation notice was output over a maximum permissible period. The output of the tank ventilation notice can be effected in response to this. The comfort of the vehicle can therefore be particularly increased.

The device may be configured to detect that the vehicle is operated in a guest and/or rental car mode (which may be stored, for example, as a flag in the storage unit (of the vehicle and/or of the backend server)). The output of the tank ventilation notice can be effected in response to this. The comfort of the vehicle can therefore be particularly increased.

The device may be configured to detect that it was stipulated in a preference setting (by the user) that no tank ventilation notices should be output. The output of the tank ventilation notice can be suppressed in response to this indication in order to further increase the comfort for the user.

The device may be configured to detect, on the basis of image data from the interior camera of the vehicle, that the user of the vehicle does not correspond to the user of the vehicle, for whom a user profile has been stored in the storage unit (of the vehicle and/or of the backend server) (and which has been selected using the vehicle key used, for example). For example, it is possible to detect that the actual user does not correspond to the user associated with the vehicle key. In this case, the output of the tank ventilation notice can be effected in order to further increase the comfort of the vehicle.

The device may be configured to ascertain the identity of the user of the vehicle on the basis of image data from the interior camera of the vehicle. It is possible to ascertain, on the basis of the identity of the user, a user profile that indicates the frequency and/or the number of past outputs of the tank ventilation notice to the user. The output of the tank ventilation notice can be effected or suppressed on the basis of the user profile, in particular on the basis of the frequency and/or number of past outputs of the tank ventilation notice to the user indicated therein. The comfort of the vehicle can therefore be increased further.

A further aspect describes a (road) motor vehicle (in particular an automobile or a truck or a bus or a motorcycle) that comprises the device described in this document.

A further aspect describes a method for controlling the output of a tank ventilation notice before a possible process of filling the fuel tank of a (motor) vehicle.

The method comprises determining that there is a notice situation, for which a tank ventilation notice should be output as standard. Furthermore, the method comprises ascertaining one or more indications of whether or not the tank ventilation notice should be suppressed, and effecting or suppressing the output of the tank ventilation notice on the basis of the one or more indications.

A further aspect describes a software (SW) program. The SW program may be configured to be executed on a processor (for example on a control unit of a vehicle) and to thereby carry out the method described in this document.

A further aspect describes a storage medium. The storage medium may comprise a SW program configured to be executed on a processor and to thereby carry out the method described in this document.

It should be noted that the methods, devices and systems described in this document can be used both alone and in combination with other methods, devices and systems described in this document. Furthermore, any aspects of the methods, devices and systems described in this document can be combined with one another in various ways. In particular, the features of the claims can be combined with one another in various ways. Furthermore, features in parentheses should be understood as being optional features.

The invention is described in more detail below on the basis of exemplary embodiments.

### BRIEF DESCRIPTION OF THE DRAWINGS

FIG. 1 shows exemplary components of a vehicle; and

FIG. 2 is a flowchart of an exemplary method for controlling the output of a tank ventilation notice.

### DETAILED DESCRIPTION OF THE DRAWINGS

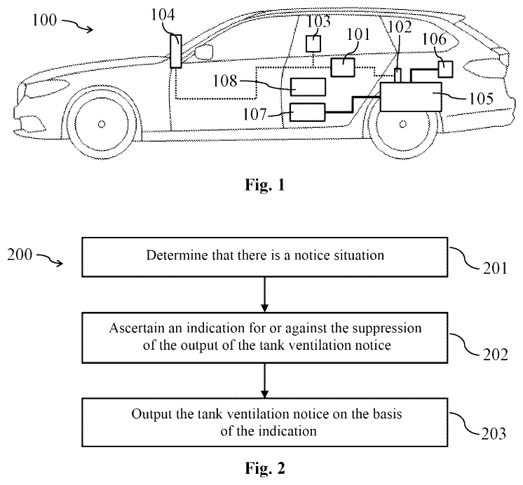

As stated at the outset, the present document deals with increasing the comfort of a user of a vehicle with respect to the tank ventilation of the fuel tank of the vehicle before carrying out a filling process. In this context, FIG. 1 shows an exemplary vehicle 100 having a fuel tank 105 for accommodating a (typically liquid) fuel (for example gasoline or diesel). The fuel can be guided into the fuel tank 105 during a filling process via a fuel tank nozzle. In this case, the fuel tank nozzle can be covered by a (possibly lockable) fuel filler flap 106.

The fuel from the fuel tank 105 can be used to operate an internal combustion engine 107 of the vehicle 100. The vehicle 100 may also have an electrical drive motor 108 which, together with the internal combustion engine 107, is part of a hybrid drive of the vehicle 100.

In a hybrid vehicle 100, it may be necessary to reduce an overpressure from the tank 105 before a filling process. In the case of a vehicle 100 having an internal combustion engine 107, this pressure can be reduced by supplying the gases to the internal combustion engine 107 for combustion. In the case of a vehicle 100 having a hybrid drive, in particular in the case of a PHEV, it may be the case, however, that the internal combustion engine 107 has not been used for a relatively long period before a filling process (since the vehicle 100 was operated in the pure electromotive mode) and the gases from the fuel tank 105 therefore cannot be guided into the internal combustion engine 107. This could result in an active carbon filter arranged at the entrance of the fuel tank 105 being oversaturated by the gases in the fuel tank 105 when the fuel filler flap 106 and/or the fuel tank nozzle is/are opened.

It may therefore be necessary for the user of the vehicle 100 to initiate the ventilation of the fuel tank 105 via a ventilation valve 102 before the filling process, for example by actuating an operating element of the user interface 104 of the vehicle 100 and/or via a software application on a user device (for example on a smartphone) belonging to the user.

The fuel filler flap 106 and/or the fuel tank nozzle can be blocked as long as the fuel tank 105 has not been ventilated. This can result in the user of the vehicle 100 not being able to carry out the filling process as long as the user has not initiated the ventilation of the fuel tank 105.

In order to provide a reminder of the ventilation of the fuel tank 105, the vehicle 100 may output a request, in particular a tank ventilation notice (for example via the user interface 104 of the vehicle 100), in order to remind the user to initiate the tank ventilation. The tank ventilation notice can be effected, for example, via a message on the information display of the vehicle 100, via an acoustic message in the audio system of the vehicle 100 and/or via a SW application on the user device belonging to the user.

The repeated output of the tank ventilation notice may be perceived to be unnecessary or annoying by an experienced user. On the other hand, the tank ventilation notice may be necessary and/or useful for an inexperienced user, in particular for a user who is not very familiar with the vehicle 100.

The (control) device 101 of the vehicle 100 may be configured to determine whether or not the user has tank ventilation experience with respect to the requirement for tank ventilation before a filling process. One or more indications may be ascertained for this purpose. Exemplary indications are:
the identity of the user, in particular of the driver, that can be ascertained, for example, on the basis of the images from an interior camera of the vehicle 100 and/or on the basis of the vehicle key belonging to the user; and/or
the number of tank ventilation notices that have already been output, for example based on a particular interval of time.

The output of the tank ventilation notice can be effected or suppressed on the basis of whether or not the user has tank ventilation experience. The comfort of the user with respect to the tank ventilation can therefore be efficiently and reliably increased.

The evaluation of a user profile (stored in a storage unit 103 of the vehicle 100 and/or of a backend server) can be used to ascertain whether the same user always used the vehicle 100 in the last x filling processes and tank ventilation notices and/or was registered as the user of the vehicle 100. In this case, it is possible to determine (possibly according to a certain logic) that the user has tank ventilation experience. Furthermore, the future display of the tank ventilation notice may be suppressed, if necessary, if the same user used the vehicle 100 in the last x filling processes and tank ventilation notices and/or was registered as the user of the vehicle 100.

Alternatively or additionally, future notice suppression can be effected on the basis of active confirmation by the user (via a user interface 104). In other words, it may be possible for the user to explicitly indicate via a user interface 104 that they have tank ventilation experience and/or that they wish to suppress the output of tank ventilation notices. The output of the tank ventilation notice can be suppressed or prevented on the basis of this.

If necessary, the vehicle 100 can be changed to a specific “guest” or “rental vehicle”/“car sharing” mode. This may be effected, for example, by an operator of the vehicle 100 (for example via the user interface 104). The mode can be indicated, for example, by a flag in the storage unit 103. If the vehicle 100 is in such a mode, it is possible to determine that the user of the vehicle 100 does not have any tank ventilation experience. In particular, it is possible to cause the tank ventilation notice not to be suppressed and/or to cause the tank ventilation notice to be displayed during each filling process.

A counter may be implemented in a user profile of a driver of the vehicle 100, which is stored locally in the vehicle 100, in particular in the storage unit 103, which counter registers how often the tank ventilation notice has already been displayed to the respective driver. If a certain number is exceeded within a certain period (for example 5 times within 50 days), it can be assumed that the driver already has tank ventilation experience. The output of the tank ventilation notice can then be suppressed.

If no filling process was then registered within the user profile of the driver for a certain pause time (for example 100 days), it may possibly be determined that the driver no longer has any tank ventilation experience. In particular, an output (possibly a one-off output) of the tank ventilation notice may be effected (as a reminder).

It may be possible for a user (for example via the user interface 104 and/or via a SW application on a user device) to fundamentally suppress the output of the tank ventilation notice in their user profile (by means of a preference setting). For this purpose, a manual setting may be made in the user profile.

The respective current user of the vehicle 100 may be identified using an interior camera of the vehicle 100. Furthermore, the user profile of the identified user can be ascertained (for example read from the storage unit 103). It may be possible to check, on the basis of the interior camera, whether the current user corresponds to the user identified by the vehicle key.

It is then possible to reliably determine, on the basis of the user profile, whether or not the user has tank ventilation experience. In particular, the output of the tank ventilation notice can be controlled on the basis of the user profile.

If it is detected, on the basis of the interior camera, that the user of the vehicle 100 does not correspond to the user identified by the vehicle key, it is possible to determine that the user does not have any tank ventilation experience, and/or the tank ventilation notice can be output.

If the vehicle 100 is used without a user profile (for example in a guest or rental car mode), the tank ventilation notice can always be output.

FIG. 2 shows a flowchart of a (possibly computer-implemented) method 200 for controlling the output of a tank ventilation notice before a possible process of filling the fuel tank 105 of a (motor) vehicle 100.

The method 200 comprises determining 201 that there is a notice situation, for which a tank ventilation notice should be output as standard. For example, it is possible to detect that the vehicle 100 is parked (possibly at a fuel pump). This can be detected, for example, on the basis of the camera data from at least one environment camera and/or on the basis of the current position of the vehicle 100 (in conjunction with a digital map relating to the road network used by the vehicle 100). Alternatively or additionally, the filling level of the fuel tank 105 can be taken into account in order to detect a notice situation. Furthermore, it is possible to check whether the fuel tank 105 needs to be ventilated before carrying out a filling process (for example because the internal combustion engine 107 of the vehicle 100 was not operated for a relatively long period directly before parking the vehicle 100).

The tank ventilation notice may be directed to requesting the user to initiate the tank ventilation of the fuel tank 105, for example by actuating an operating element.

The method 200 also comprises ascertaining 202 one or more indications of whether or not the tank ventilation notice should be suppressed. Exemplary indications are:
the identity of the user and a user profile associated with the user;
the frequency and/or the number of previously output tank ventilation notices (possibly specifically to the user); and/or
the operation of the vehicle 100 in a guest and/or rental car mode.

Furthermore, the method 200 comprises effecting or suppressing 203 the output of the tank ventilation notice on the basis of the one or more indications.

The comfort of a user of a vehicle 100 with respect to tank ventilation processes can be efficiently and reliably increased by means of the measures described in this document.

The present invention is not restricted to the exemplary embodiments shown. In particular, it should be noted that the description and the figures are intended to illustrate, only by way of example, the principle of the proposed methods, devices and systems.

List of reference signs

| | |
|---|---|
| 100 | Vehicle |
| 101 | (Control) device |
| 102 | Tank ventilation valve |
| 103 | Storage unit |
| 104 | User interface |
| 105 | Fuel tank |
| 106 | Fuel filler flap |
| 107 | Internal combustion engine |
| 108 | Electrical drive machine |
| 200 | Method for controlling the output of a tank ventilation |
| | notice |
| 201-203 | Method steps |

1.-6. (canceled)

7. A device for controlling an output of a tank ventilation notice before a possible process of filling a fuel tank of a vehicle, the device comprising:
a computer implemented control unit operatively configured to:
determine that there is a notice situation, for which the tank ventilation notice should be output as standard;
ascertain one or more indications of whether or not the tank ventilation notice should be suppressed, wherein the one or more indications are ascertained based on:
a user profile of a user that is stored in a storage unit;
a preference setting of the user with respect to the output of tank ventilation notices;
whether or not there is a user profile stored in the storage unit for the user of the vehicle;
an identity of the user ascertained based on image data from an interior camera of the vehicle; and/or
operation of the vehicle in a guest and/or rental car mode; and
effect or suppress the output of the tank ventilation notice based on the one or more indications.

8. The device according to claim 7, wherein the control unit is further configured to:
detect that the vehicle is operated in a guest and/or rental car mode; and
effect the output of the tank ventilation notice in response to the detection.

9. The device according to claim 7, wherein the control unit is further configured to:
detect a stipulation in a preference setting that no tank ventilation notices should be output; and
suppress the output of the tank ventilation notice in response to the detection.

10. The device according to claim 7, wherein the control unit is further configured to:
detect, on the basis of the image data from the interior camera of the vehicle, that the user of the vehicle does not correspond to the user of the vehicle for whom a user profile has been stored in a storage unit of the vehicle and/or of a backend server; and
effect the output of the tank ventilation notice in response to the detection.

11. The device according to claim 7, wherein the control unit is further configured to:
ascertain the identity of the user of the vehicle based on the image data from the interior camera of the vehicle;
ascertain, based on the identity of the user, a user profile that indicates a frequency and/or a number of past outputs of the tank ventilation notice to the user; and
effect or suppress the output of the tank ventilation notice based on the frequency and/or number of past outputs of the tank ventilation notice to the user indicated therein.

12. A method for controlling an output of a tank ventilation notice before a possible process of filling a fuel tank of a vehicle; the method comprising the steps of:
determining that there is a notice situation, for which a tank ventilation notice should be output as standard;
ascertaining one or more indications of whether or not the tank ventilation notice should be suppressed; wherein the one or more indications are ascertained based on:
a user profile of the user stored in a storage unit;
a preference setting of the user with respect to the output of tank ventilation notices;
whether or not there is a user profile stored in the storage unit for the user of the vehicle;
an identity of the user based on image data from an interior camera of the vehicle; and/or
operation of the vehicle in a guest and/or rental car mode; and
effecting or suppressing the output of the tank ventilation notice based on the one or more indications.
